(19) United States
(12) Patent Application Publication
(10) Pub. No.: US 2012/0011818 A1
(43) Pub. Date: Jan. 19, 2012

(54) MOVABLE MOUNTING ASSEMBLY FOR THE GATHERING ROLLS OF A HARVESTER

(76) Inventor: Christopher Cannavan, Queensland (AU)

(21) Appl. No.: 13/138,773

(22) PCT Filed: Mar. 24, 2010
(86) PCT No.: PCT/AU2010/000342

§ 371 Date: Sep. 26, 2011

(30) Foreign Application Priority Data
Mar. 24, 2009 (AU) 2009901244

(51) Int. Cl. A01D 57/22

(52) U.S. Cl. 56/14.3

(57) ABSTRACT

A movable mounting assembly for the gathering rolls of a harvester including at least a pair of gathering rolls, each gathering rolls mounted for movement between a use condition in which the roll is positioned forwardly of the harvester and a non-use condition wherein the roll is retracted to shorten the effective length of the harvester in order to improve maneuverability.

### FIELD OF THE INVENTION

The present invention relates to sugar cane harvesters and more particularly to adaptations to sugar cane harvesters to make them more manoeuvrable.

### BACKGROUND ART

Attachments and adaptations to sugarcane harvesters are known. For example, U.S. Pat. No. 4,512,142 to Landry et al. provides an attachment for a sugarcane harvester for gathering, severing and chopping or shredding the non-millable, immature top portion of a sugarcane stalk so that the remaining millable portion of the sugarcane stalk can be harvested by the sugarcane harvester in a conventional manner. The attachment includes a scroll-type gathering system interconnected with a rotary knife assembly to form one integral unit with a knife assembly which includes a unique arrangement or radial and longitudinal blades mounted on a drum or cylinder which rotates about an axis which is inclined upwardly and forwardly at a fixed angle to vertical to provide more effective shredding of the non-millable cane top with the gathering system enabling the sugarcane harvester to more efficiently handle brittle sugarcane varieties with reduced breakage of the brittle stalk, thereby enabling sugarcane growers to utilise more brittle sugarcane species which are resistant to smut and other diseases as well as insects with the efficient shredding of the came top permitting increased cane sugar borer control by eliminating a significant portion of the winter habitat of the sugarcane borer.

The harvester disclosed in that document also includes a frame structure pivotally supported at its rear to the harvester vehicle. A hydraulically operated power mechanism can be used to elevate the forward end of the harvester. The frame structures are rigid with each other and are supported by carriage rollers supported in trackways carried by upright supporting structures forming part of the vehicle and which extend above the supporting wheels on the vehicle.

The vertical adjustment of the gathering system and rotary knife assembly disclosed in that document are to enable the height at which the sugar cane tops are severed to be adjusted depending upon the height of the crop being harvested.

This adjustment mechanism disclosed is provided for a specific purpose and therefore, includes elements which are directed towards raising and lowering the gathering system rather than moving the gathering system into a non-use condition such that the gathering system is at least temporarily stored above and partially behind the front axle of the harvester.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a movable mounting assembly for the gathering rolls of a harvester, which may at least partially overcome at least one of the abovementioned disadvantages or provide the consumer with a useful or commercial choice.

With the foregoing in view, the present invention in one form, resides broadly in a movable mounting assembly for the gathering rolls of a harvester including at least a pair of gathering rolls, each gathering rolls mounted for movement between a use condition in which the roll is positioned forwardly of the harvester and a non-use condition wherein the roll is retracted to shorten the effective length of the harvester in order to improve manoeuvrability.

In an alternative embodiment, the present invention resides in a movable mounting assembly for the gathering rolls of a harvester, the harvester having at least a pair of gathering rolls, each mounted on at least one arm member, at least one of the harm members mounted coaxially with a forward axle of the drive means of the harvester, and the gathering rolls pivotal between a non-use condition in which they are located above and at least partially behind the forward axle of the harvester and at least one use condition in which the gathering rolls are located in front of the forward axle.

In a further alternative embodiment, the present invention resides in a movable mounting assembly for the gathering rolls of a harvester, the harvester having at least two gathering rolls each mounted on at least one forward arm member and at least one rearward arm member, the forward arm member mounted to the harvester at a first mounting point adjacent the front drive means of the harvester and the rearward arm member mounted coaxially with a forward axle of the drive means of the harvester, the gathering rolls pivotable between a non-use condition in which they are located above and at least partially behind the forward axle and at least one use condition in which the gathering rolls are located in front of the forward axle.

The principle of the movable mounting assembly of the present invention is to move the gathering rolls of a harvester from their use condition in front of the wheels of a track of the harvester to a non-use condition in order to shorten the effective length of the harvester. This invention will enable the harvester to be more easily manoeuvred at the end of a crop row in order to reposition the harvester for harvesting the next row.

The gathering rolls of a harvester are typically elongate and auger-shaped. The harvester normally has a frame or chassis with a number of wheels to support the harvester above the ground or a track for example. Normally, the forwardmost wheel (or the forward most guide wheel for a track) has an axle extending substantially perpendicular to the direction of travel.

It is particularly preferred that the mounting assembly of the present invention is located or mounted relative to the forward most axle of the harvester.

In its most preferred form, at least one and typically a plurality of linkage arms are used to mount each gathering roll relative to the frame or chassis of the harvester in order to accomplish the movement of the gathering rolls.

Normally, the movement of the gathering rolls from the use condition to the non-use condition and vice versa will be powered movement and will be controlled in order to properly locate and adjust the location of the gathering rolls in both the use and the non-use conditions. Preferably, a hydraulic system will be provided to accomplish this movement and control. The control system is preferably one in which once actuated, the movement between the two conditions is automatic. A memory module may be provided to govern the position of the gathering rolls in each of the conditions.

Other systems such as a compressed air ram would also achieve similar functionality.

According to the most preferred form, at least one first linkage arm is mounted for rotation about the front most axle of the harvester. Additionally, at least one second linkage arm is preferably mounted for rotation about a pivot point formed forward of, but immediately adjacent, the forward most wheel or portion of a track for the harvester.

Preferably, each gathering roll will be mounted on a mounting arm extending substantially parallel to an axis of rotation of the gathering roll. The preferred linkage arms are then preferably pivotally attached to the mounting arm.

In the use condition according to one preferred form, each gathering roll is preferably positioned extending at approximately 45° to the ground surface upwardly and rearwardly towards the harvester. According to this preferred form, each gathering roll will be positioned either substantially horizontally or substantially vertically when in the non-use condition. According to the most preferred form of this embodiment, each gathering roll will be substantially horizontal when in the non-use condition.

Where provided, the linkage arms may be length adjustable.

It is also preferred that the gathering rolls are mounted relative to the frame or chassis of the harvester directly in front of the wheels or tracks. In this embodiment, when in the non-use condition, the gathering rolls are located above the wheels.

It is preferred that the forward portion of the gathering rolls will be located above and substantially in line with, the forwardmost extremity of the harvester when in the non-use condition. This will typically result in the greatest possible reduction in effective length of the harvester. The inventor of the present invention has found that the length of the harvester can be reduced by up to approximately 2.5 meters utilising the invention.

According to a particularly preferred embodiment, there may be a pair of second linkage arm members provided for each gathering roll, and inside linkage arm member and an outside linkage arm member. Where a pair of second linkage arm members is provided, it is preferred that the pair is provided in a substantially triangular configuration when viewed from above. Each of the pair of second linkage arm members will preferably be attached to a pivot mount extending laterally in front of the forward most wheel or track of the harvester.

Typically, the at least one first linkage arm member may be provided to move the gathering rolls with the second linkage arm members to guide and position the gathering rolls correctly in both the use and non-use condition.

The gathering rolls and the movable mounting assembly may be adapted to allow adjustment of the position of the gathering rolls toward and away from the centre of the row of the crop as well as to move the gathering rolls between the use and non-use conditions.

Normally, the wheels or tracks of the harvester are mounted on arms which diverge from the main frame or chassis of the harvester in order to position the wheels or tracks outside the row of the crop to be harvested.

The movable mounting assembly for each roll may be independent or the movement may be sympathetic with two or more gathering rolls moving in the same direction at the same time. For example, a double row harvester will typically have four gathering rolls, two outer gathering rolls and two inner gathering rolls. In one embodiment, the two outer gathering rolls may move upwardly and rearwardly while the inner two gathering rolls may move rearwardly and downwardly. In that embodiment, the inner two gathering rolls will typically be mounted inside, and move inside, the front wheels or tracks of the harvester whilst the outer two gathering rolls will typically be mounted outside, and move upwardly and rearwardly to a position at least partially above the front wheel or track of the harvester.

### BRIEF DESCRIPTION OF THE DRAWINGS

Various embodiments of the invention will be described with reference to the following drawings, in which:

FIG. 1 is an isometric view of a movable mounting assembly for a gathering roll of a harvester of one preferred embodiment in the non-use condition.

FIG. 2 is an isometric view of the movable mounting assembly illustrated in FIG. 1 but in the use condition.

FIG. 3 is a front view of a movable mounting assembly for a gathering roll of a harvester of one preferred embodiment in the non-use condition.

FIG. 4 is a front view of the movable mounting assembly illustrated in FIG. 3 but in the use condition.

FIG. 5 is a side view of a movable mounting assembly for a gathering roll of a harvester of one preferred embodiment in the non-use condition.

FIG. 6 is a side view of the movable mounting assembly illustrated in FIG. 5 but in the use condition.

FIG. 7 is a side view of the link trajectory of the preferred embodiment of movable mounting assembly illustrated in FIGS. 1-6.

In the accompanying figures, only a single gathering roll has been illustrated for simplification purposes. Normally, a mirror of the illustrated system will be installed on the opposite side of the chassis or frame.

### DETAILED DESCRIPTION OF THE PREFERRED EMBODIMENT

According to a particularly preferred embodiment, a movable mounting assembly for the gathering rolls of a harvester is provided.

According to one preferred embodiment illustrated, the harvester has at least two gathering rolls 10 (only one of which is illustrated). Each gathering roll 10 is mounted on a pair of forward arm members 11 and a rearward arm member 12. The forward arm members 12 are mounted to the harvester at a first mounting point 13 adjacent the front wheel 14 of the harvester and the rearward arm member 12 is mounted coaxially with a forward axle 15 of the front wheel 14 of the harvester.

Each of the pair of forward linkage arm members 12 attached to a pivot mounting member 17 extending laterally in front of the forward most wheel or track of the harvester.

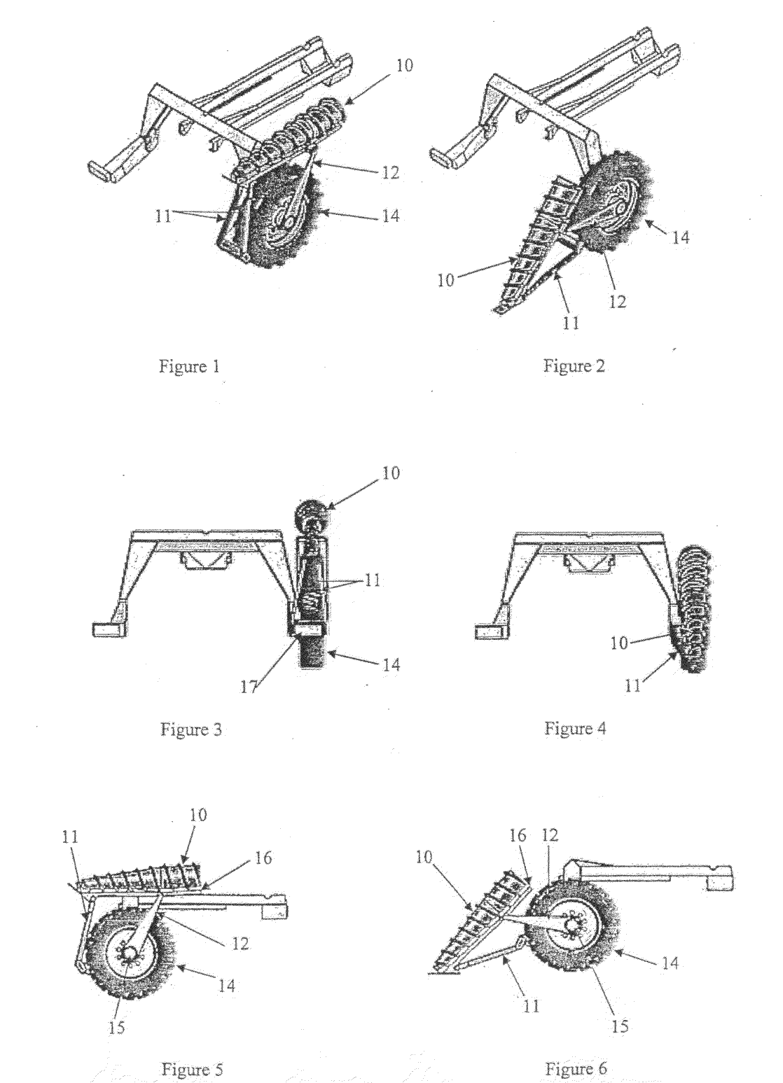

The gathering rolls 10 are therefore pivotable between a non-use condition in which they are located above, depicted in FIGS. 1, 3 and 5 and at least partially behind the forward axle 15 and at least one use condition in which the gathering rolls 10 are located in front of the forward axle , depicted in FIGS. 2, 4 and 6.

The gathering rolls 10 of a harvester are elongate and auger shaped. The harvester normally has a frame or chassis with a number of wheels to support the harvester above the ground or a track for example. Only a portion of the chassis is depicted in the Figures for simplicity.

Normally, the movement of the gathering rolls from the use condition to the non-use condition and vice versa is powered movement and is controlled in order to properly locate the gathering rolls 10 in both the use and the non-use conditions. Preferably, a hydraulic system will be provided to accomplish this movement and control.

According to the illustrated form, a rearward linkage arm 12 is mounted for rotation about the front most axle 15 of the harvester. A pair of second linkage arms is mounted for rotation about a pivot point 13 formed forward of but immediately adjacent, the forward most wheel 14 of the harvester.

Each gathering roll 10 is mounted on a mounting arm 16 extending substantially parallel to the axis of rotation of the gathering roll 10. The linkage arms 11, 12 are then pivotally attached to the mounting arm 16.

In the use condition illustrated, each gathering roll 10 is positioned extending at approximately 45° to the ground surface upwardly and rearwardly towards the harvester. According to the illustrated form, each gathering roll 10 is positioned substantially horizontally when in the non-use condition.

As illustrated in FIGS. 3 and 4 in particular, the gathering rolls 10 are mounted relative to the frame or chassis of the harvester directly in front of the wheels 14. In this embodiment, when in the non-use condition, the gathering rolls 10 are located above the wheels 14.

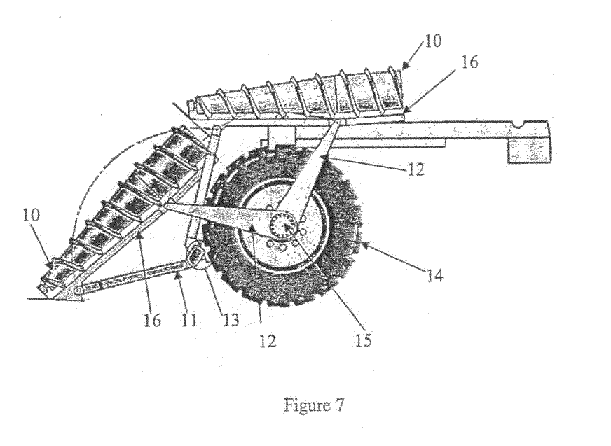

As illustrated in FIG. 7, it is preferred that the forward portion of the gathering rolls 10 will be located above and substantially in line with the forward most extremity of the harvester when in the non-use condition. This will typically result in the greatest possible reduction in effective length of the harvester.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A movable mounting assembly for the gathering rolls of a harvester including at least a pair of gathering rolls, each gathering rolls mounted for movement between a use condition in which the roll is positioned forwardly of the harvester and a non-use condition wherein the roll is retracted to shorten the effective length of the harvester in order to improve maneuverability.

2. A movable mounting assembly for the gathering rolls of a harvester as claimed in claim 1 wherein the movement of the gathering rolls from the use condition to the non-use condition and vice versa is powered movement.

3. A movable mounting assembly for the gathering rolls of a harvester as claimed in claim 1 wherein the movement of the gathering rolls from the use condition to the non-use condition and vice versa is controlled in order to properly locate and adjust the location of the gathering rolls in both the use and non-use conditions.

4. A movable mounting assembly for the gathering rolls of a harvester as claimed in claim 1 further including a memory module to govern the position of the gathering rolls in each of the conditions.

5. A movable mounting assembly for the gathering rolls of a harvester as claimed in claim 1 wherein a plurality of linkage arms are provided to mount each gathering roll relative to a frame or chassis of the harvester in order to accomplish the movement of the gathering rolls.

6. A movable mounting assembly for the gathering rolls of a harvester as claimed in claim 5 wherein at least one first linkage arm is mounted for rotation about a front most axle of the harvester.

7. A movable mounting assembly for the gathering rolls of a harvester as claimed in claim 6 wherein at least one second linkage arm is mounted for rotation about a pivot point formed forward of, but immediately adjacent, a forward most wheel or portion of a track for the harvester.

8. A movable mounting assembly for the gathering rolls of a harvester as claimed in claim 7 wherein a pair of second linkage arm members are provided for each gathering roll, an inside linkage arm member and an outside linkage arm member, each of the pair of second linkage arm members attached to a pivot mount extending laterally in front of the forwarwd most wheel or track of the harvester.

9. A movable mounting assembly for the gathering rolls of a harvester as claimed in claim 7 wherein the at least one first linkage arm member moves the gathering rolls with at least one second linkage arm members to guide and position the gathering rolls correctly in both the use and non-use conditions.

10. A movable mounting assembly for the gathering rolls of a harvester as claimed in claim 9 wherein the linkage arms are length adjustable.

11. A movable mounting assembly for the gathering rolls of a harvester as claimed in claim 1 wherein the gathering rolls are mounted relative to the harvester such that when in the non-use condition, the gathering rolls are located above any wheels or tracks of the harvester.

12. A movable mounting assembly for the gathering rolls of a harvester as claimed in claim 11 wherein a forward portion of the gathering rolls is located above and no further forwardly than the forwardmost extremity of the harvester when in the non-use condition.

13. A movable mounting assembly for the gathering rolls of a harvester as claimed in claim 1 wherein the gathering rolls and the movable mounting assembly are adapted to allow adjustment of the position of the gathering rolls laterally toward and away from a crop row as well as to move the gathering rolls between the use and non-use conditions.

14. A movable mounting assembly for the gathering rolls of a harvester, the harvester having at least a pair of gathering rolls, each mounted on at least one arm member, at least one of the arm members mounted coaxially with a forward axle of the drive means of the harvester, and the gathering rolls pivotal between a non-use condition in which they are located above and at least partially behind the forward axle of the harvester and at least one use condition in which the gathering rolls are located in front of the forward axle.

15. A movable mounting assembly for the gathering rolls of a harvester, the harvester having at least two gathering rolls each mounted on at least one forward arm member and at least one rearward arm member, the forward arm member mounted to the harvester at a first mounting point adjacent the front drive means of the harvester and the rearward arm member mounted coaxially with a forward axle of the drive means of the harvester, the gathering rolls pivotable between a non-use condition in which they are located above and at least partially behind the forward axle and at least one use condition in which the gathering rolls are located in front of the forward axle.
